(19) United States
(12) Patent Application Publication
(10) Pub. No.: US 2026/0223779 A1
(43) Pub. Date: Aug. 6, 2026

(54) IMPELLER BLOWER ASSEMBLY FOR A CROP RESIDUE CHOPPING AND DISTRIBUTION ARRANGEMENT OF A COMBINE HARVESTER AND ASSOCIATED IMPELLER PADDLE

(71) Applicant: DEERE & COMPANY, MOLINE, IL (US)

(72) Inventors: SWARUPANAND PATIL, PUNE (IN); TUSHAR NARLAWAR, PUNE (IN); DIRK SCHUBERT, Matzenbach (DE); OLIVER DAHLHAUSER, Mauschbach (DE); DARSHAN PANDHARINATH JADHAV, PUNE (IN)

(21) Appl. No.: 19/416,637

(22) Filed: Dec. 11, 2025

(30) Foreign Application Priority Data
Feb. 5, 2025 (EP) 25156061.1

(51) Int. Cl. A01D 41/12

(52) U.S. Cl. CPC A01D 41/1243

(57) ABSTRACT

An impeller blower assembly for a crop residue chopping and distribution arrangement of a combine harvester having a rotor which is rotatable about an axis of rotation, and around the circumference of which a number of impeller paddles are distributed, includes the impeller paddles composed of and manufactured form ductile cast iron.

### CROSS-REFERENCE TO RELATED APPLICATIONS

This application claims the priority benefit of EP 25156061.1, filed on Feb. 5, 2025. All of the above applications are incorporated by reference herein and are to be considered a part of this specification. Any and all applications for which foreign or domestic priority claim is identified in the Application Data Sheet as filed with the present application are hereby incorporated.

### TECHNICAL FIELD

The disclosure generally relates to an impeller blower assembly for a crop residue chopping and distribution arrangement of a combine harvester with a rotor which is rotatable about an axis of rotation and around the circumference of which a number of impeller paddles are distributed, and an associated impeller paddle.

### BACKGROUND

Agricultural combine harvesters are large machines which harvest, thresh, separate and clean agriculturally cultivated crops which contain grain. The clean grain obtained is stored in a grain tank arranged on the combine harvester. The threshed straw is generally either chopped up and distributed on the field over the width of the cutting unit or guided around the straw chopper and deposited in an un-chopped form in a swathe on the field to be able to be collected later with a baler. The crop residues which remain at the rear outlet of the cleaning device, such as chaff and small pieces of straw, are distributed on the field by a chaff spreader or conducted through the straw chopper and distributed on the field.

Since combine harvesters have been provided with ever greater outputs in recent decades which require larger cutting unit widths and thus also larger distribution widths which cannot be achieved by the straw choppers on their own, so-called impeller blowers which accelerate and eject the crop residues are used downstream of the straw chopper. The impeller blowers are normally arranged in pairs next to one another and comprise rotors arranged in a housing which are set in rotation by means of a drive.

In the prior art, the rotors are provided with paddles in order to accelerate the crop residues. This can involve inherently flat or inherently twisted paddles or paddles bent in another manner, as shown e.g. in DE 199 08 111 C1, DE 101 33 965 A1, DE 10 2010 002 467 A1, EP 3 537 866 A1 and US 2007/0 015 556 A1, or the paddles are equipped at their outer ends with acutely tapering or cylindrical, finger-like elements (EP 2347 645 A1, EP 3 228 174 A1, EP 4 115 723 A1).

In the prior art, the flat paddles are composed of injection-molded plastic or metal. In particular, flat paddles manufactured from cast steel are used (EP 4 115 723 A1). In the prior art, cylindrical paddles formed as finger rakes are manufactured from spring steel or from forged steel.

It has been shown in practice that the paddles manufactured from spring steel have an inadequate service life, while forged steel requires higher manufacturing costs.

### SUMMARY

The disclosure provides an impeller paddle that is manufactured from ductile cast iron. This involves a material which is characterized by low manufacturing costs, low weight, a low degree of wear and high stability and is particularly well suited for use as an impeller paddle. Ductile cast iron can be easily cast and better finished (ground) by machine and is more cost-effective than steel. It furthermore has improved resistance to abrasion and a higher tensile yield point than cast steel which furthermore requires complex and expensive processing tools. The unit costs for the impeller paddle made of ductile cast iron are lower than those for a similar impeller paddle made of cast steel.

The impeller paddles can be embodied as a one-piece finger rake which comprises a proximal fastening section which can be or is connected detachably to a holder of the rotor, and from which a number of fingers extend up to a distal end of the impeller paddle. The fingers preferably lie in a common plane and form a finger rake. The fingers can lie in a common plane with the fastening section and the fingers have a rectangular cross-section, the extent of which is greater in the common plane than in the direction perpendicular to the common plane. The fingers can taper continuously from the fastening section starting from the distal end in the direction perpendicular to the common plane and have a width which is constant over the length of the fingers when measured in the common plane.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

An exemplary embodiment of the disclosure will be explained on the basis of the drawings.

FIG. 1 is a schematic, partially sectional, lateral view of a combine harvester with a straw chopper and impeller blowers.

FIG. 2 is a schematic, perspective view of the impeller blower from the rear and below.

FIG. 3 is a schematic perspective view of a blower paddle.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

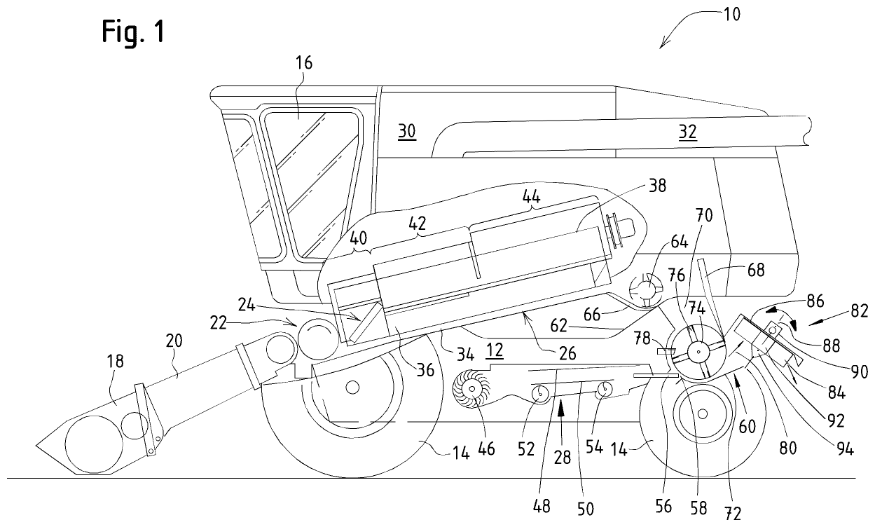

Referring to the Figures, wherein like numerals indicate like parts throughout the several views, FIG. 1 shows an agricultural combine harvester 10 having a chassis 12 with wheels 14 engaging the ground, which are fixed to the chassis 12 and which are used to drive the combine harvester 10 forward in a forward direction, which in FIG. 1 runs to the left. The operation of the combine harvester 10 is controlled from the operator's cab 16. A cutting mechanism 18 is used to harvest crop containing grain and to feed it to a feeder house 20. The harvested material is fed through the feeder house 20 to a guide drum 22. The guide drum 22 guides the crop through an inlet transition section 24 to an axial crop processing device 26. In the following, directional statements such as front and rear refer to the forward direction of the combine harvester 10, which runs to the left in FIG. 1.

The crop processing device 26 comprises a rotor housing 34 and a rotor 36 arranged therein. The rotor 36 comprises a hollow drum 38, to which material processing elements for a charging section 40, the threshing section 42 and a separation section 44 are fastened. The charging section 40 is arranged on the front side of the axial crop processing unit 26. In the longitudinal direction, the threshing section 42 and the separation section 44 are located downstream and rearward of the charging section 40. The drum 38 has the shape of a truncated cone in the charging section 40. The threshing section 42 comprises a front section in the shape of a truncated cone and a cylindrical rear section. At the end of the axial crop processing unit 26 there is the cylindrical separation section 44 of the drum 38. Instead of an axial crop-processing unit 26, a tangential threshing drum and an axial separator or straw walker following it can also be used.

Grain and chaff which fall through a threshing concave assigned to the threshing section 42 and a separator grate assigned to the separation section 44 are fed to a cleaning system 28 having a blower 46 and a slatted screen 48, 50 that can set to vibrating. The cleaning system 28 removes the chaff and leads the clean grain via a screw conveyor 52 to an elevator for clean grain (not shown). The clean grain elevator deposits the clean grain in a grain tank 30. The clean grain in the grain tank 30 can be unloaded onto a grain cart, trailer or truck by an unloading screw conveyor 32. Crop remaining at the rear end of the lower slatted screen 50 is fed to the crop processing device 26 again by means of a screw conveyor 54 and a tailings conveyor (not shown). The crop residues discharged at the rear end of the upper slatted screen 48, which substantially comprise chaff and small straw particles, are conveyed by a vibratory pan conveyor 56 to the rear into a lower inlet 58 of a straw chopper 60.

Threshed straw leaving the separation section 44 is discharged from the crop processing device 26 through an outlet 62 and fed to a discharge drum 64. The discharge drum 64 interacting with the ground 66 arranged underneath it discharges the straw rearward. A wall 68 which directs the straw into an upper outlet 70 of the straw chopper 60 is located at the rear side of the discharge drum 64.

The straw chopper 60 is composed of a housing 72 and a rotor 74 which is arranged therein and is rotatable about an axis 74 running transversely to the forward direction and running horizontally with chopper blades 76 which are distributed around the circumference of the rotor 74, are suspended in pairs so as to swing about and interact with counterpart blades 78 fixed on the housing. Two impeller blowers 82 arranged laterally next to one another, of which only one is apparent in FIG. 1, is provided downstream of an outlet 80 of the straw chopper 60.

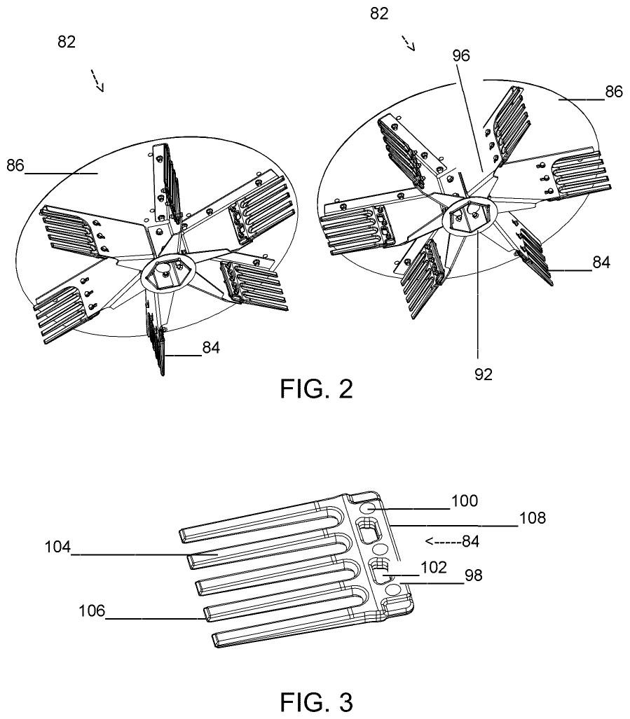

The impeller blowers 82 comprise a number of impeller paddles 84 which are each connected rigidly to an upper, circular disc 86 which are rotatable about central axes of rotation 88. The discs 86 with the radially extending impeller paddles 84 can be set in rotation in each case by a hydraulic motor 90 which is attached above a bottom plate 102 which is connected to the housing 72 of the straw chopper 60. The impeller paddles 84 are screwed at their radially inner ends with radially extending fastening plates 96 which serve as a holder for the impeller paddles 84, the fastening plates 96 themselves being connected to a central body 92 which can transition into a pointed cone 94 on its side facing away from the disc 86. The impeller paddles 84 are embodied in one piece and as finger rakes and the height of the body 92 (without a cone 94 which is not shown in FIG. 2 and can also be omitted) is equal to the height of the impeller paddles 84.

The straw chopper 60 defines an outlet plane which extends obliquely to the rear and upwards and in which the crop residues are discharged. The impeller paddles 84 of the impeller blower 82, however, rotate in an impeller blower plane which is inclined to the rear and downwards. The impeller blower plane of the impeller blower 82 is thus inclined to the rear and downwards with respect to the outlet plane of the straw chopper 60. The crop residues are conveyed by the impeller blower 82 in the impeller blower plane and discharged to the rear and to the side and distributed over the field across the width of the cutting mechanism 18. Further details, also in relation to a possible housing of the impeller blower 82, can be found in DE 10 2008 040 129 B4, the disclosure of which is incorporated by reference into the present documents.

Reference is now made to FIG. 3 in which an impeller paddle 84 is shown in a perspective view. The impeller paddle 84 comprises a proximal, radially inner fastening region 98 in the position fastened on the impeller blower 86, which fastening region 98 defines an inner, proximal end 108 of the impeller paddle 84. The fastening region 98 comprises a number of smaller holes 100 which serve to receive screws with which the impeller paddle 84 is fixed on the fastening plate 96. Larger openings 102 which lie between the holes 100 with a trapezoidal cross-section serve the purpose of reducing weight.

The impeller paddles 84 furthermore comprise a number of fingers 104, in the represented embodiment five fingers 104, although more or fewer fingers 104 than shown could also be present. The fingers 104 extend parallel to one another, starting from the fastening region 98 to an outer, distal end 106 and clearances remain between adjacent fingers. The fingers 104 accordingly form a finger rake. The fingers 104 lie in a common plane with the fastening region 98. The dimensions of the fingers 104 in the plane occupied by the fastening region 98 and the fingers 104 are, if one considers the transverse direction with respect to the longitudinal extent of the fingers 104, approximately constant, while the fingers taper in the direction oriented transversely to the stated plane from the proximal, inner end of the fingers 104 to the outer, distal end 106, i.e. become ever thinner transversely to the plane towards the outside. One accordingly obtains a type of carrier of the same strength which is characterized by elasticity and long durability. The dimensions of the fingers 104 in the transverse direction lying in the stated plane are greater than those in the direction perpendicular thereto. The cross-section of the fingers 104 is approximately rectangular with rounded corners.

The impeller paddle 84 is manufactured in one piece in a casting process from ductile cast iron. For this purpose, a model of the impeller paddle is firstly manufactured which is slightly larger than the impeller paddle 84 after cooling. A two-piece mold which is filled with the molten metal is manufactured by means of the model. The mold is separated after cooling, the impeller paddle 84 is removed and finished (grinding, priming).

A suitable material for the ductile cast iron is JDM B8 grade N550B06, i.e. a cast, ductile iron with a matrix microstructure composed of perlite and ferrite (typical matrix phase distribution with more than 50% perlite), a tensile strength of more than 550 MPa, a tensile yield point of more than 350 MPa and a tensile yield point of more than 6% and a hardness of 173 to 255 HBW. The carbon proportion may be between 3% and 3.9%. The ductile cast iron enables manufacture of the impeller paddles from lightweight, low-cost, wear-resistant and solid material, which is well suited for the present use as an impeller paddle for an impeller blower assembly of a combine harvester. The material can correspond to the standard EN-GJS-500-7 (GGG50).

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. An impeller blower assembly for a crop residue chopping and distribution arrangement of a combine harvester, the impeller blower assembly comprising:
a rotor which is rotatable about an axis of rotation;
a number of impeller paddles distributed around a circumference of the rotor; and
wherein the impeller paddles are composed of ductile cast iron.

2. The impeller blower assembly set forth in claim 1, wherein the impeller paddles are a one-piece finger rake which includes a proximal fastening section which is connected detachably to a holder of the rotor, and from which a number of fingers extend out to a distal end of the impeller paddle.

3. The impeller blower assembly set forth in claim 2, wherein the fingers lie in a common plane and form a finger rake.

4. The impeller blower assembly set forth in claim 3, wherein the fingers lie in the common plane with the fastening section.

5. The impeller blower assembly set forth in claim 3, wherein the fingers have a rectangular cross-section, the extent of which is greater in the common plane than in the direction perpendicular to the common plane.

6. The impeller blower assembly according to claim 5, wherein the fingers taper continuously in a direction perpendicular to the common plane from the fastening section to the distal end of the fingers.

7. The impeller blower assembly set forth in claim 6, wherein the fingers have a width, measured in the common plane, which is constant over a length of the fingers between the fastening section and the distal end of the fingers.

8. An impeller paddle for attachment to a rotor of an impeller blower assembly for a crop residue chopping and distribution arrangement of a combine harvester, the impeller paddler comprising:
an integral one-piece finger rake including a fastening section configured for detachable attachment to a holder of the rotor, and a number of fingers extending out from the fastening section to a distal end; and
wherein the integral one-piece finger rake is composed of ductile cast iron.

9. The impeller paddle set forth in claim 8, wherein the fingers lie in a common plane and form the finger rake.

10. The impeller paddle set forth in claim 9, wherein the fingers lie in a common plane with the fastening section.

11. The impeller paddle set forth in claim 10, wherein the fingers have a rectangular cross-section, the extent of which is greater in the common plane than in a direction perpendicular to the common plane.

12. The impeller paddle set forth in claim 11, wherein the fingers narrow continuously in a direction perpendicular to the common plane, starting from the fastening section and moving toward the distal end of the fingers.

13. The impeller paddle set forth in claim 12, wherein the fingers have a width which is constant over the length of the fingers between the fastening section and the distal end of the fingers when measured in the common plane.
